(19) United States
(12) Patent Application Publication
(10) Pub. No.: US 2007/0089366 A1
(43) Pub. Date: Apr. 26, 2007

(54) Water-wicking plant container for supporting and lifting a potted plant

(76) Inventor: Victor M. Kasatshko, Tarpon Springs, FL (US)

Correspondence Address: GORDON & JACOBSON, P.C., 60 LONG RIDGE ROAD, SUITE 407, STAMFORD, CT, 06902, US

(21) Appl. No.: 11/257,921

(22) Filed: Oct. 25, 2005

(51) Int. Cl. A01G 25/00

(52) U.S. Cl. 47/81

(57) ABSTRACT

A plant container includes a support structure sized to fit within a pot. The support structure includes a flexible polymeric mesh and water-wicking material that cooperate to support and contain growing medium and a plant root structure therein. At least one wick member extends from the bottom wall of the support structure and has a terminal portion that is placed in a water reservoir. An electronic water level sensing and alarm circuit is preferably supported by the support structure. At least one pair of conducting wires is electrically coupled to the electronic circuit and extends from the electronic circuit to the terminal portion of said member. The electronic circuit raises an alarm in the event that water level in the water reservoir is below the predetermined threshold level. Hand lifting means are connected to (or part of) the support structure for manual lifting of the container together with the growing medium and plant for quick and efficient transplantation between pots with minimal mess.

### BACKGROUND OF THE INVENTION

1. Field of the Invention

This invention relates broadly to containers that hold a growth medium as well as the root structure of a plant therein. More particularly, the invention relates to containers that provide for wicking of water from a water storage reservoir. It also relates to containers that provide for quick and efficient transplantation of the plant between different pots.

2. Background of the Invention

Potted plants employ a pot to contain and support a growth medium (e.g. soil and/or other particulate matter) as well as the root structure of a plant therein. Such pots typically have a truncated cone shape and are realized by plastic or clay materials. Such pots are also commonly placed within a decorative planter for improved visual impact.

It is often necessary to transplant a potted plant from one pot to another, for example, when the root structure outgrows the pot that it is in. Such transplantation is a time-consuming and messy task, which typically results in spillage of the growing medium that is not tightly bound to the root structure of the potted plant.

Pots also typically have one or more openings in their bottom wall for adequate drainage. As shown in U.S. Pat. No. 5,647,170 to Holtkamp, Jr., it is known to use such openings as part of a self-watering pot by placing one end of the wick in a water reservoir and inserting the opposite end of the wick into the soil of the potted plant. The pot is then supported over (or adjacent to) the water reservoir. The wick transmits water from the water reservoir to the growing medium that surrounds it by capillary action. This arrangement works adequately; however, only the immediate area surrounding the wick receives water and it is often difficult to determine if the water level of the water reservoir is low and thus requires refilling, thereby minimizing the benefits afforded by the self-watering wicks.

Therefore, there remains a need in the art for improved container for a plant that provides for quick and efficient transplantation of the plant from one pot to another. Such a container also should provide for self-watering in a manner that delivers water to a large area of the growing medium of the plant while allowing end users to easily maintain adequate water levels for supply to the growing medium.

### SUMMARY OF THE INVENTION

It is therefore an object of the invention to provide an improved container for a plant that provides for quick and efficient transplantation of the plant from one pot to another.

It is another object of the invention to provide such a plant container that is capable of self-watering the plant in a manner that delivers water to a large area of the growing medium of the plant and allows end users to easily maintain adequate water levels for supply to the growing medium.

It is a further object of the invention to provide such a plant container that works in conjunction with a pot and water reservoir for self-watering a plant.

In accord with these objects, which will be discussed in detail below, an improved plant container includes a support structure sized to fit within a pot. The support structure includes a flexible polymeric mesh and water-wicking material that cooperate to support and contain growing medium and a plant root structure therein. At least one wick member extends from the bottom wall of the support structure and has a terminal portion that is placed in a water reservoir during use. An electronic circuit for sensing whether water level in the water reservoir is below a predetermined threshold level is preferably supported by the support structure. At least one pair of conducting wires is electrically coupled to the electronic circuit and extends from the electronic circuit to the terminal portion of the wick member. The electronic circuit raises an alarm (e.g., a visual and/or audible alarm) in the event that water level in the water reservoir is below the predetermined threshold level. Hand lifting means are connected to (or part of the support structure).

It will be appreciated that the plant container of the present invention accommodate manual lifting of the container together with the growing medium and plant for quick and efficient transplantation between pots with minimal mess. Moreover, the water-wicking material of the support and wick extensions and the electronic water level sensor and alarm system built therein provides for self-watering of the plant in a manner that allows end users to easily maintain adequate water levels for supply to the growing medium of the plant.

According to one embodiment of the invention, three wick extensions extend from the bottom wall of the support structure. Preferably, two wick extensions are disposed opposite one another and extend from respective peripheral portions of the bottom wall that are located adjacent the outer circumference of the bottom wall. The third wick extension is preferably disposed midway between the other two wick extensions and extends from the central region of the bottom wall.

Additional objects and advantages of the invention will become apparent to those skilled in the art upon reference to the detailed description taken in conjunction with the provided figures.

### BRIEF DESCRIPTION OF THE DRAWINGS

FIG. 1 is a pictorial illustration of a plant container in accordance with the present invention.

FIG. 2 is a partial blown-up view of the bottom portion of the plant container of FIG. 1.

FIG. 3 is an exploded view of an apparatus for self-watering a plant that employs the plant container of FIG. 1 in accordance with the present invention.

FIG. 4 is an illustration showing the general dimensions of an exemplary embodiment of the plant container of FIG. 1.

### DETAILED DESCRIPTION OF THE PREFERRED EMBODIMENTS

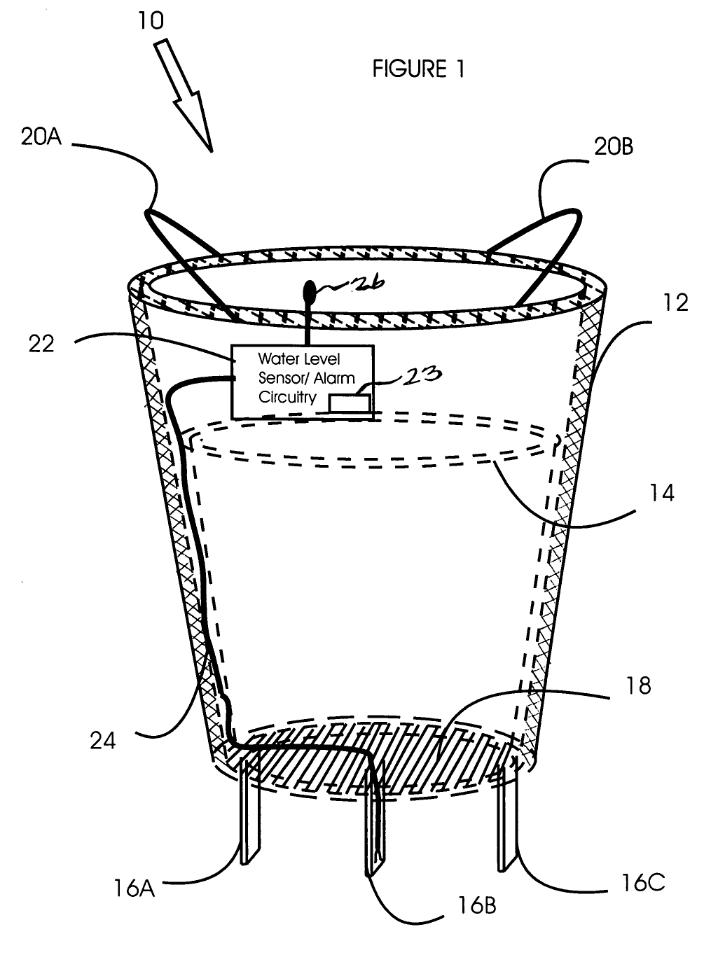

Turning now to FIG. 1, there is shown a plant container 10 in accordance with the present invention, including an outer mesh liner 12 that interfaces to an inner water-wicking liner 14, both of which preferably have truncated conical shapes as shown. The outer mesh liner 12 provides a structure for supporting the inner-wicking liner 14 as well as the growing medium and root structure of the plant as described herein. The outer mesh liner 12 is realized from strands of a flexible polymeric material (e.g., nylon strands) that are overlaid upon one another in a net-like fashion and joined together at overlapping points. In the preferred embodiment, the outer mesh liner 12 is realized by 15 pound nylon strands. The outer mesh liner 12 is secured to the inner water-wicking liner 14 by hot gluing, stitching or other suitable methods. The inner water-wicking liner 14 may be realized by a wicking fabric such as felt, a chamois-like microfiber material, or some other material that provides for water transport to the growing medium via capillary action.

The inner water-wicking liner 14 (and optionally the outer mesh liner 12) form a bottom wall 18. Three wick extensions 16A, 16B, 16C extend from the water-wicking liner bottom wall 18. Preferably, two wick extensions (16A, 16C) are disposed opposite one another and extend from respective peripheral portions of the bottom wall 18 that are located adjacent the outer circumference of the bottom wall 18. The wick extension 16B is preferably disposed midway between the two wick extensions 16A, 16C and extends from the central region of the bottom wall 18 as shown. In the preferred embodiment, the wick extensions 16A, 16B, 16C are on the order of 1 inch in width and 4 inches long, but may be 6 inches long or more in applications that employ very deep water reservoirs. The three wick extensions 16A, 16B, 16C and the water-wicking liner 14 coupled thereto cooperate to automatically transport water to the growing medium via capillary action from a water reservoir below the container as described below.

A set of flexible handles (two shown as 20A, 20B) are affixed to the outer mesh liner 12. In the preferred embodiment, the handles 20A, 20B are on the order of four inches in length and are capable of supporting the weight of the container 10 together with the growing medium and the plant supported therein. The handles 20A, 20B are realized from a flexible material (e.g., nylon strands) such that they can rest against the top rim of the outer mesh liner 12 (or a position adjacent thereto) and remain out of the way and preferably hidden from view when not in use. In alternate embodiments, more than two handles, such as four or even six handles, can be used. It is also contemplated that the handles may be realized by transverse slits through the outer mesh liner 12 in the vicinity of the top rim of the mesh liner 12. Such slits may be reinforced with glue or other material in order to accommodate lifting the weight of the container together with the growing medium and the plant supported therein.

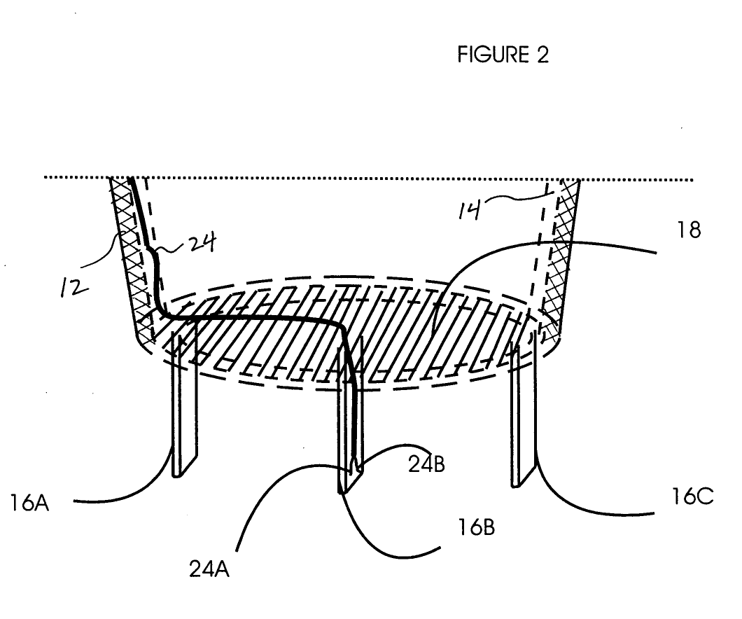

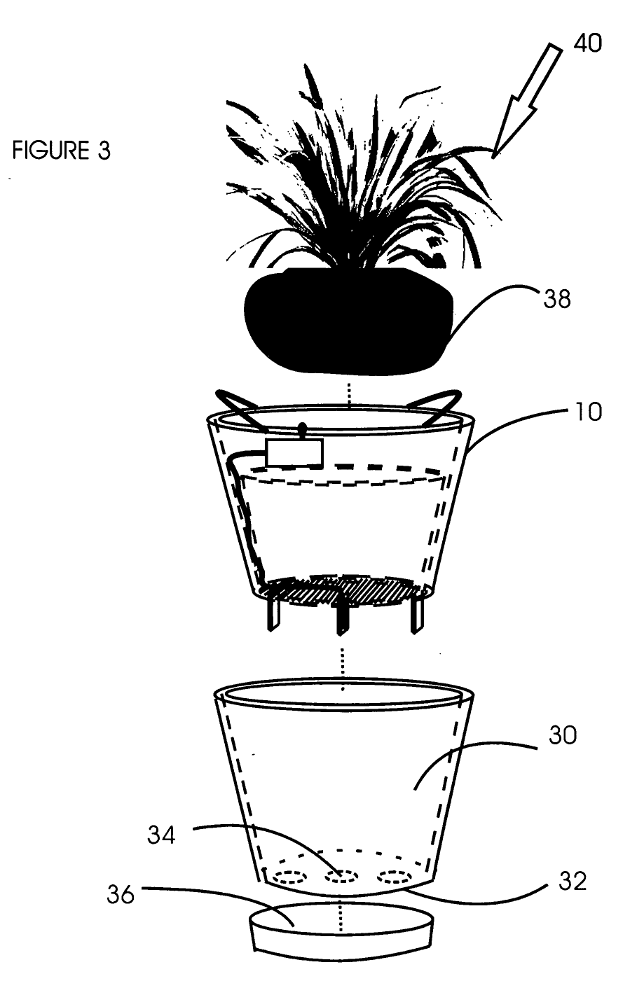

The container 10 also supports an electronic water level sensor and alarm system having an electronic circuit board 22 that is preferably mounted adjacent the top rim of the outer mesh liner 12 as shown. The circuit board 22 is encapsulated in a waterproof case (not shown). A wire lead pair 24 extends from the electronic circuit board 22 to the bottom wall 18 and down the central wick extension 16B. In the preferred embodiment, the wire lead pair 24 is realized by a plastic or epoxy coated wire pair in order to resist corrosion. The two wire leads 24A, 24B are preferably separated from one another at or near the bottom end of the central wick extension 16B as shown in FIG. 2. The central wick extension 16B extends into a water reservoir (FIG. 3). The electronic circuit board 22 is powered by a power source (e.g., battery 23) typically located on the board 22 and functions to detect the absence of electronic current flowing between the two wire leads 24A, 24B. In the absence of such current flow, the circuitry activates an alarm. The alarm preferably comprises a visual alarm such as an LED 26 that is activated by supplying the LED with current that drives it into its light emitting state. The alarm might also include an audible alarm (e.g., a buzzer or a pre-recorded message/song that is played through a speaker). Current flow between the two leads is dictated by the water level within the reservoir relative to the two wire leads 24A, 24B. In the event that the water level within the reservoir reaches (or extends above) the predetermined threshold level dictated by the position of the two wire leads 24A, 24B, electric current will flow between the two leads and the alarm(s) are inactive. However, in the event that the water level within the reservoir is below the two wire leads 24A, 24B, electric current will not flow between the two leads and the alarm(s) are activated. In alternate embodiments, additional wire leads can be employed to detect and alarm multiple water levels (e.g., a low water level and a high water level).

As shown in the exploded view of FIG. 3, the container 10 fits within a pot 30. The bottom wall 32 of the pot 30 includes three openings 34 that correspond to the three wick extensions 16A, 16B, 16C. The wick extensions 16A, 16B, 16C extend through these openings such that their terminal portions are inserted into the water reservoir 36. Conventional plant pots have a single central opening. For these conventional pots, the end user may be instructed to cut out peripheral openings for the peripheral wick extensions. A template may be provided to aid the user in such operations. Alternatively, the end user may omit such operations and only use the central wick extension 16B in conjunction with the central opening in the pot 30. The water reservoir 36 is disposed under the bottom wall 32 of the pot 30. A growth medium 38, typically soil and/or a similar loose particulate compound, fills a portion of the interior space defined by the inner water-wicking liner 14. The root structure of the plant 40 grows within the growth medium 38. The three wick extensions 16A, 16B, 16C and the water-wicking liner 14 coupled thereto cooperate to automatically transport water to the growing medium via capillary action from the water reservoir 36.

In the event that the plant 40 requires transplantation, the end user can quickly and efficiently remove the growing medium 38 and the plant 40 from the pot 30 by lifting the container 10 by the handles 20A, 20B. The inner liner 14 contains the growing medium 38 and the root structure of the plant 40 in a manner that allows for neat and orderly transplantation thereof. If the plant is to be transplanted into a pot that is significantly larger than the container 10, it is contemplated that the end use might cut the liners 12, 14 lengthwise with a knife or other sharp blade in order to allow the roots to grow into the surrounding growth medium in the new pot.

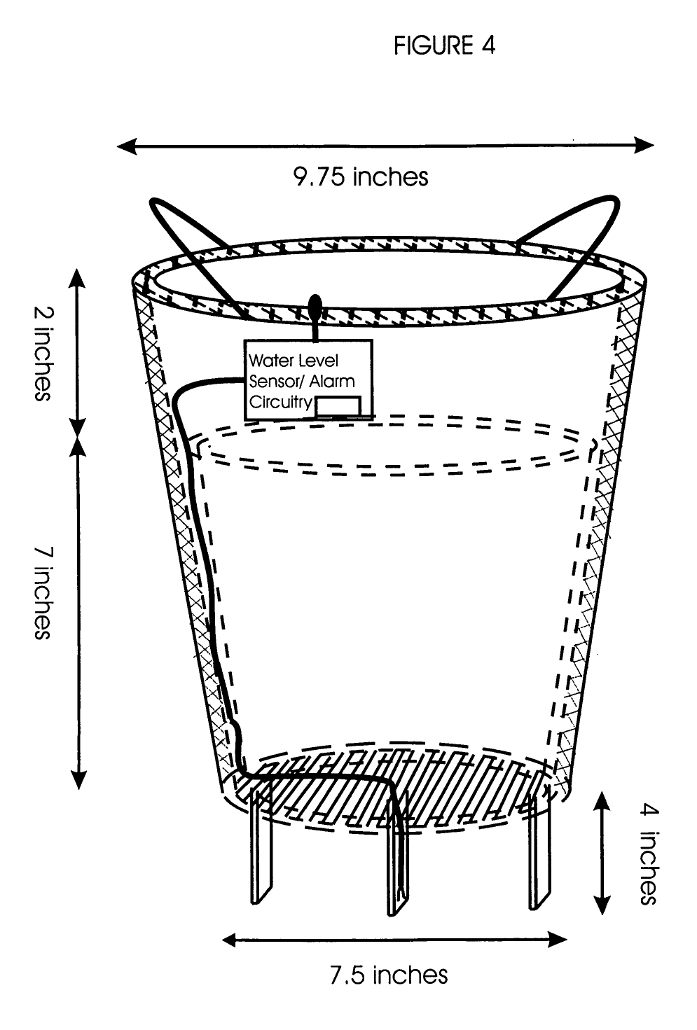

FIG. 4 illustrates the general dimensions of an exemplary embodiment of the plant container 10 described herein. It is contemplated that the outer mesh liner 12 will extend to the top rim of the pot 30. It might even extend beyond this top rim. The inner water-wicking liner 14 extends 2 inches below the top of the outer mesh liner 12. Alternatively, it too can extend to the top rim of the pot 30. Note that the water-wicking liner 14 may not wick water to its full height. However, it may extend upward beyond its maximum wicking capability in order to provide a barrier to the growth medium 38 such that it does not spill out from the container during transplantation as described herein.

Advantageously, the plant container of the present invention and self-watering apparatus based thereon provides for quick and efficient transplantation of the plant from one pot to another with minimal spillage of the growing medium. Moreover, such systems provide for self-watering of the plant in a manner that allows end users to easily maintain adequate water levels for supply to the growing medium of the plant.

There have been described and illustrated herein an embodiment of an improved plant container for self-water applications and apparatus based thereon. While a particular embodiment of the invention has been described, it is not intended that the invention be limited thereto, as it is intended that the invention be as broad in scope as the art will allow and that the specification be read likewise. Thus, while a particular shape has been disclosed, it will be appreciated that other shapes can be used as well. In addition, while particular configurations of the mesh liner and water-wicking liner have been disclosed, it will be understood that other configurations can be used. For example, and not by way of limitation, it is contemplated that the water-wicking material may be integrated with a flexible mesh support as part of a unitary structure that supports and contains the growing medium and the root structure of the plant. Moreover, while a particular configuration has been disclosed in reference to size, shape and location of the wick extensions, it will be appreciated that other configurations could be used as well. It will therefore be appreciated by those skilled in the art that yet other modifications could be made to the provided invention without deviating from its spirit and scope as claimed.

What is claimed is:

1. A plant container for containing a growing medium and a plant root structure disposed within the growing medium, the plant container for use in conjunction with a pot, the plant container comprising:
a support structure sized to fit within the pot, said support structure comprising a flexible polymeric mesh and water-wicking material that cooperate to support and contain the growing medium and the plant root structure, said support structure having a bottom wall;
at least one member that extends from said bottom wall of the support structure, said at least one member realized from water-wicking material.

2. A plant container according to claim 1, wherein:
said at least one member has a terminal portion that is placed in a water reservoir during use.

3. A plant container according to claim 2, wherein:
said at least one member comprises a linear arrangement of three members that extend from said bottom wall of said support structure, a first member extending from a central region of said bottom wall and disposed between two other members extending from peripheral regions of said bottom wall.

4. A plant container according to claim 2, further comprising:
an electronic circuit for sensing whether water level in the water reservoir is below a predetermined threshold level, said electronic circuit supported by said support structure; and
at least one pair of conducting wires that are electrically coupled to said electronic circuit and that extend from said electronic circuit to said terminal portion of said member.

5. A plant container according to claim 4, wherein:
said electronic circuit raises an alarm in the event that water level in the water reservoir is below the predetermined threshold level.

6. A plant container according to claim 5, wherein:
said alarm comprises at least one of a visual alarm and an audible alarm.

7. A plant container according to claim 6, wherein:
said visual alarm comprises an LED that is placed in a light emitting state in the event that water level in the water reservoir is below the predetermined threshold level.

8. A plant container according to claim 6, wherein:
said audible alarm comprises one of a buzzer and a pre-recorded message.

9. A plant container according to claim 1, wherein:
said support structure comprises an outer mesh liner comprising polymeric mesh, said outer mesh liner surrounding an inner water-wicking liner.

10. A plant container according to claim 9, wherein:
said outer mesh liner is sized such that it extends adjacent the top lip of the pot.

11. A plant container according to claim 10, wherein:
said inner water-wicking liner is sized such that it extends to a point below the top lip of the pot.

12. A plant container according to claim 1, wherein:
said polymeric mesh comprises nylon strands.

13. A plant container according to claim 1, wherein:
said water-wicking material comprises felt.

14. A plant container according to claim 1, wherein:
said water-wicking material comprises a chamois-like microfiber material.

15. A plant container according to claim 1, wherein:
said water-wicking material provides for water transport to the growing medium via capillary action.

16. A plant container according to claim 1, further comprising:
hand lifting means connected to or part of said support structure for accommodating manual lifting of said support structure together with the growing medium and plant.

17. A plant container according to claim 16, wherein:
said hand lifting means comprises a plurality of handles affixed to said support structure.

18. A plant container according to claim 16, wherein:
said hand lifting means comprises a plurality of reinforced slits through portions of said support structure.

19. An apparatus for automatic watering of a plant comprising:
a pot with a bottom wall having at least one opening therethrough;
a water reservoir disposed below said pot;
a container for containing a growing medium and a plant root structure disposed within the growing medium, the container including a support structure sized to fit within the pot, the support structure comprising a flexible polymeric mesh and water-wicking material that cooperate to support and contain the growing medium and the plant root structure, said support structure having a bottom wall; and
at least one member that extends from said bottom wall of the support structure, said at least member realized from water-wicking material, said at least one member having a terminal portion that extends through an opening though said bottom wall of said pot such that it is inserted in said water reservoir.

20. An apparatus according to claim 19, wherein:
said at least one member comprises a linear arrangement of three members that extend from said bottom wall of said support structure, a first member extending from a central region of said bottom wall and disposed between two other members extending from peripheral regions of said bottom wall, wherein respective terminal portions of said three members extend through corresponding openings in said bottom wall of said pot for insertion into the water reservoir.

21. An apparatus according to claim 19, further comprising:
an electronic circuit for sensing whether water level in the water reservoir is below a predetermined threshold level, said electronic circuit supported by said support structure; and
at least one pair of conducting wires that are electrically coupled to said electronic circuit and that extend from said electronic circuit to said terminal portion of said member.

22. An apparatus according to claim 21, wherein:
said electronic circuit raises an alarm in the event that water level in said water reservoir is below the predetermined threshold level.

23. An apparatus according to claim 22, wherein:
said alarm comprises at least one of a visual alarm and an audible alarm.

24. An apparatus according to claim 23, wherein:
said visual alarm comprises an LED that is placed in a light emitting state in the event that water level in said water reservoir is below the predetermined threshold level.

25. An apparatus according to claim 23, wherein:
said audible alarm comprises one of a buzzer and a pre-recorded message.

26. An apparatus according to claim 19, wherein:
said support structure comprises an outer mesh liner comprising polymeric mesh, said outer mesh liner surrounding an inner water-wicking liner.

27. An apparatus according to claim 26, wherein:
said pot has a top lip and said outer mesh liner is sized such that it extends adjacent said top lip of said pot.

28. An apparatus according to claim 27, wherein:
said inner water-wicking liner is sized such that it extends to a point below said top lip of said pot.

29. An apparatus according to claim 19, wherein:
said polymeric mesh comprises nylon strands.

30. An apparatus according to claim 19, wherein:
said water-wicking material comprises felt.

31. An apparatus according to claim 19, wherein:
said water-wicking material comprises a chamois-like microfiber material.

32. An apparatus according to claim 19, wherein:
said water-wicking material provides for water transport to the growing medium via capillary action.

33. An apparatus according to claim 19, further comprising:
hand lifting means connected to or part of said support structure for accommodating manual lifting of said support structure together with the growing medium and plant.

34. An apparatus according to claim 33, wherein:
said hand lifting means comprises a plurality of handles affixed to said support structure.

35. An apparatus according to claim 33, wherein:
said hand lifting means comprises a plurality of reinforced slits through portions of said support structure.
